(19) United States
(12) Patent Application Publication
(10) Pub. No.: US 2008/0235428 A1
(43) Pub. Date: Sep. 25, 2008

(54) METHOD AND SYSTEM FOR DYNAMIC SWITCHING BETWEEN MULTIPLEXED INTERFACES

(75) Inventors: Chia-Hsing Yu, Taipei County (TW); Lin-Hung Chen, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/759,360

(22) Filed: Jun. 7, 2007

(30) Foreign Application Priority Data
Mar. 20, 2007 (TW) 96109495

(51) Int. Cl. G06F 13/36

(52) U.S. Cl. 710/309; 710/306

(57) ABSTRACT

A bridge is disclosed. The bridge comprises a first interface having at least one multiplexed clock signal line. The multiplexed clock signal line outputs first and second control signals for respectively controlling the access to first and second devices coupled to the bridge. The bridge selectively outputs the first clock signal or the second clock signal to the multiplexed clock signal line to access the first device or the second device respectively.

### BACKGROUND OF THE INVENTION

1. Field of the Invention

The invention relates to a bridge and interface control method thereof, and more particularly, to a bridge capable of dynamically switching between different interfaces and an interface control method thereof.

2. Description of the Related Art

Serial peripheral interface (SPI) and low pin count (LPC) are two popular interfaces for data transmission in a conventional chipset or bridge design of electronic systems. LPC interface, or the LPC bus, is typically used in connecting devices with lower bandwidth, e.g. a bootable read only memory (ROM) or a super input/output device, to the central control unit (CPU). The LPC interface specifies seven major signals to perform bi-directional data transmission in which three of seven major signals LPC_FRAME, LPC_RST and LPC_CLK are control signals and remaining four signals LPC-AD[3:0] are data signals. LPC_FRAME signal is a frame bit signal for enabling a LPC device which is a device with LPC interface to start data access thereby. LPC_RST signal is a reset signal, LPC_CLK signal is a clock signal and data signals LPC-AD[3:0] are utilized for multitasking commands, addresses and data. SPI specifies clock signal SPI_CLK, master data output and slave data input (MOSI) control signal SPI_MOSI, master data input and slave data output (MISO) control signal SPI_MOSO and chip select control signal SPI_CS. The SPI_CS control signal is utilized for enabling a SPI device, which is a device with a SPI such as a SPI flash memory, to start the data accessing via the SPI. The clock signal SPI_CLK provides required clock signal for SPI while the input signal SPI_MOSI and the output signal SPI_MOSO are utilized for data transmission. Generally, codes of the basic input output system (BIOS) for an electronic system reside in a LPC ROM. Thus, a bridge has to provide at least same number of the pins corresponding to the aforementioned LPC signals to provide a LPC interface such that the bridge is coupled to the LPC ROM via the LPC interface. In current implementations, however, codes of the BIOS may reside in a SPI flash memory. To provide the SPI, the bridge has to provide at least the same number of pins (i.e. four) as the aforementioned SPI signals such that the bridge is coupled to the SPI flash memory via the SPI. Therefore, to access the LPC ROM or SPI flash memory, support of both the LPC interface and the SPI are required in a conventional system design.

FIG. 1 shows a conventional electronic system 100. The electronic system 100 comprises at least a bridge 110, a LPC device 120 and a SPI device 130. The LPC device 120 and SPI device 130 are coupled to the bridge 110 via the LPC interface 140 and SPI 150 respectively. As shown, since the specification for the SPI is different from that of the LPC interface, the bridge 110 has to provide two groups of independent pins for both the LPC interface and the SPI. Thus, the size and pins required for the bridge will be increased, and the design of the bridge complicated.

### BRIEF SUMMARY OF THE INVENTION

Accordingly, the invention provides a bridge design and interface control method thereof for dynamically switching between different interfaces to provide simple and flexible design and reduce the pin number requirement.

In an embodiment, a bridge comprises at least one multiplexed clock signal line and a plurality of data signal lines. The bridge selectively outputs a first clock signal or a second clock signal to the multiplexed clock signal line according to an operating mode for accessing a first device or a second device coupled to the bridge respectively.

An electronic system is further disclosed, comprising at least a first device, a second device and a bridge. The first device has a first interface, and the second device has a second interface. The bridge comprises at least a clock pin and a plurality of data pins. The clock pin is coupled to both the first and second devices. The bridge selectively outputs a first clock signal or a second clock signal to the clock pin according to an operating mode for accessing the first device or the second device respectively. The first interface is coupled to the data pins and the second interface is coupled to a part of the data pins.

### BRIEF DESCRIPTION OF THE DRAWINGS

The invention can be more fully understood by reading the subsequent detailed description and examples with reference to the accompanying drawings, wherein:

FIG. 1 shows a conventional electronic system;

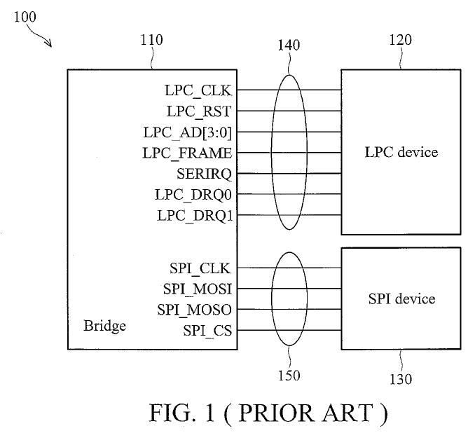

FIG. 2 shows an embodiment of an electronic system according to the invention;

FIG. 3 is a block diagram of a bridge according to the invention;

FIG. 4 is a flowchart of an interface control method according to the invention;

FIG. 5 is an exemplary timing diagram according to the invention; and

FIG. 6 shows another embodiment of an electronic system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention relates to a bridge design, wherein the bridge comprises at least one multiplexed interface providing two interfaces with two kinds of specifications. The multiplexed interface comprises at least one multiplexed clock signal line, or multiplexed clock pins, and a first clock signal (LPC_CLK) and a second clock signal (SPI_CLK) are selectively output to the multiplexed clock signal line to access a first device (LPC device) and a second device (SPI device) in which the first and second devices are coupled to the bridge. The first device has a LPC interface and the second device has a SPI, and the first and second devices are coupled to the multiplexed interface of the bridge via the LPC interface and the SPI respectively. In operation, the bridge selectively outputs the first or the second clock signal on the multiplexed signal line according to an operating mode for the access to the first or the second device. With sharing of the pins of the LPC interface and the SPI, the pin number required for the bridge can be reduced and the design of the bridge simplified. Embodiments of the invention also provide methods for dynamically switching between different interfaces to switch the output signal on the multiplexed interface dynamically based on the operating modes, making the design flexible.

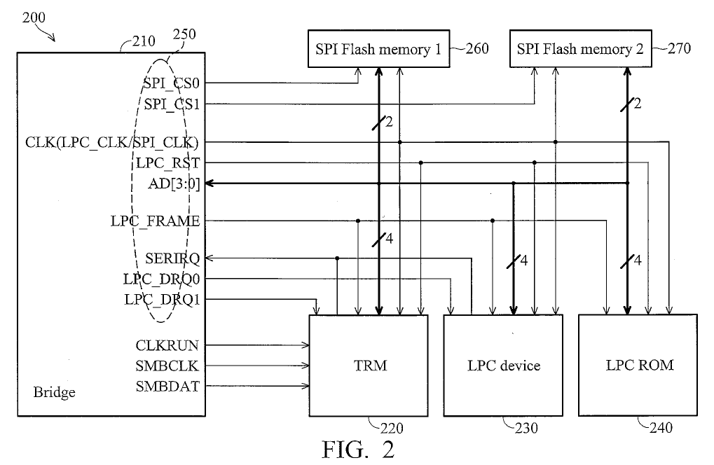

FIG. 2 shows an embodiment of an electronic system according to the invention. The electronic system 200 comprises a bridge 210, LPC devices 220, 230 and 240, and SPI devices 260 and 270. The bridge 210 comprises at least one multiplexed interface 250, and the LPC devices 220-240 and SPI devices 260-270 are coupled to the bridge 210 through the multiplexed interface 250. Each of the LPC devices 220, 230 and 240 has a LPC interface while each of the SPI devices 260 and 270 has a SPI. The LPC devices 220, 230 and 240 are coupled to the multiplexed interface 250 of the bridge 210 through the LPC interface thereof. Similarly, the SPI devices 260 and 270 are coupled to the multiplexed interface 250 of the bridge 210 through the SPI thereof. The LPC device may be any device using a LPC interface for data transmission. For example, in this embodiment, the LPC device 220 is a trusted platform module (TPM), one of the applications of the LPC interface, performing data encryption/decryption and hardware key verification, as a security device. Moreover, the LPC device 220 also couples to the bridge 210 via a SM bus having signal lines CLKRUN, SMBCLK and SMBDAT (shown in the FIG. 2) for data transmission therethrough. The LPC device 230 may be a super input/output (I/O) device and the LPC device 240 may be a LPC ROM for storing codes of the BIOS for booting the system while it's powered up. In addition, the SPI devices 260 and 270 may be any device using a SPI for data transmission, such as SPI flash memory1 260 and SPI flash memory2 270 as shown in FIG. 2.

As shown in FIG. 2, the multiplexed interface 250 of the bridge 210 comprises at least following signal lines (or pins): selection signal lines SPI_CS0 and SPI_CS1; multiplexed clock signal line CLK (LPC_CLK/SPI_CLK); reset signal line LPC_RST; data signal lines AD[3:0]; and trigger signal line LPC_FRAME. The multiplexed clock signal line CLK (LPC_CLK/SPI_CLK), the reset signal line LPC_RST, the data signal lines AD[3:0] and the trigger signal line LPC_FRAME are utilized to provide signals needed for forming a LPC interface to couple to the LPC devices 220-240. Furthermore, the selection signal lines SPI_CS0 and SPI_CS1, the multiplexed clock signal line CLK and any two of the data signal lines AD[3:0] (e.g. data signal lines AD1 and AD0) are utilized to provide signals needed for forming a SPI to couple to the SPI devices 260 and 270. In this embodiment, the multiplexed clock signal line CLK and the data signal lines AD1 and AD0 are shared so that the pin number required for the bridge can be reduced by at least three. For example, if the pin number of the multiplexed interface is M, the LPC device is coupled to all M pins of the multiplexed interface and the SPI device is coupled to N pins of the M pins of multiplexed interface, where N<M, N>0 and M>1. In this embodiment, two of the data signals and the multiplexed clock signal line CLK are shared (i.e. N=3) by the LPC device and SPI device, and thus the bridge requires only 8 pins, compared to the conventional bridge design requiring 11 pins (seven for LPC interface and four for SPI).

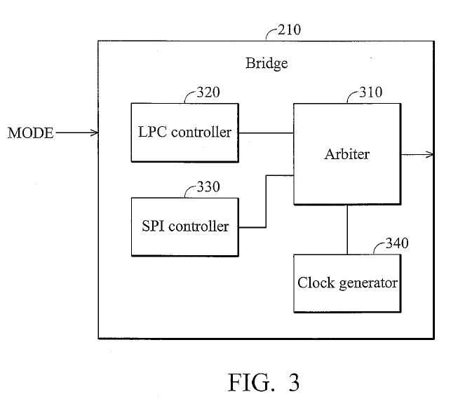

FIG. 3 shows a block diagram of bridge 210 according to an embodiment of the invention. As shown, the bridge 210 includes an arbiter 310, a LPC controller 320, a SPI controller 330 and a clock generator 340. The arbiter 310 determines to output a first clock signal LPC_CLK or a second clock signal SPI_CLK to the multiplexed clock signal line CLK according to an operating mode MODE, wherein the operating mode MODE is a predefined parameter determined in advance. The operating mode MODE can be obtained in advance by a device above the bridge, such as a Southbridge chipset. For example, the control unit of the system will inform the Southbridge chipset about which of the LPC device and the SPI device is being accessed. For the control unit of the system, it is known in advance which device will be accessed during a specific time period. Therefore, the arbiter 310 is capable of acquiring this predefined information relating to the operating mode (i.e. which device is to be accessed) and controlling or adjusting the outputs of the shared signal lines for the multiplexed interface to access the LPC device or the SPI device.

For example, if the operating mode is to access the LPC device 230, the arbiter 310 outputs a first clock signal LPC_CLK that is compatible with the LPC standard to the multiplexed clock signal line CLK using the clock generator 340, and selects a LPC data generated by the LPC controller 320 for output to the data signal lines AD[3:0]. Meanwhile, the bridge 210 outputs an enabling signal on the trigger signal line LPC_FRAME of the LPC device 230, by pulling down the signal level to Low level “L” or generating a pulse signal from low level “L” to high level “H”, to enable the access to the LPC device 230. The LPC device 230 is then starting to access the LPC data through the coupled multiplexed interface. Alternatively, if the operating mode is to access the SPI ROM 260, the arbiter 310 outputs a second clock signal SPI_CLK that is compatible with the SPI standard to the multiplexed clock signal line CLK using the clock generator 340, and selects SPI data generated by the SPI controller 330 for output to one of the data signal lines AD[3:0], i.e. AD1. The data signal line AD1 is coupled to the input signal line SPI_MOSI of the SPI ROM 260 as a signal input source of the SPI ROM 260. Meanwhile, the bridge 210 outputs an enabling signal on the selection signal line SPI_CS0 of the SPI ROM 260, by pulling down the signal level to Low level “L”, to enable access to the SPI ROM 260. The SPI ROM 260 then accesses the SPI data through the coupled multiplexed interface. The first and second clock signals LPC_CLK and SPI_CLK are with a first and a second frequency respectively, with the first frequency different from the second frequency, the first frequency compatible with the LPC standard, and the second frequency compatible with the SPI standard.

Therefore, according to the embodiment of the invention, device access can be dynamically switched between the LPC device 230 and the SPI flash memory 260 based on the operating mode by controlling the output of the multiplexed clock signal line CLK and that of the data signal lines AD[3:0] within the bridge 210.

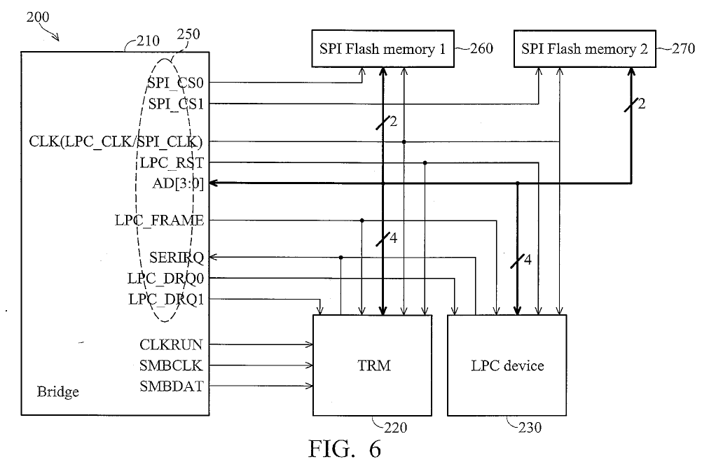

As shown in FIG. 2, the code of the BIOS resides in the LPC ROM 240. However, in other embodiments, the codes of the BIOS may reside in the SPI flash memory 260 or 270, removing the usage of the LPC ROM (as shown in FIG. 6). In this case, with the embodiment of the bridge of the invention, the pin number required for the bridge for access between the SPI flash memory and the LPC device can be further reduced, making the design of the bridge more easy and flexible. It is to be understood that, referring to FIG. 2, in other embodiments, it is possible to implement a pure LPC ROM design by removing the SPI flash memory 260 and 270 of the FIG. 2.

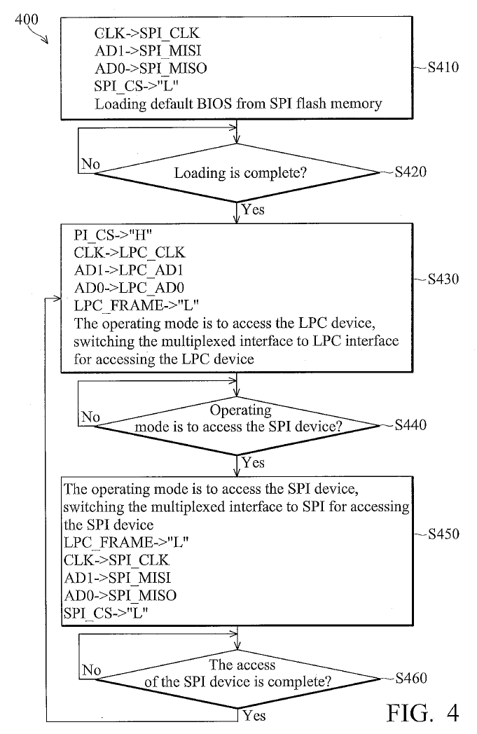

FIG. 4 is a flowchart of an interface control method 400 of the invention. It is assumed that, in this embodiment, the system comprises LPC device and one of the SPI flash memories, such as SPI flash memory 260, of FIG. 2, and the codes of the BIOS reside in the SPI flash memory 260. Initially, the selection signal of the LPC device and the control signal of the SPI flash memory are disabled i.e. configured to high signal level “H”. It is to be noted that the LPC device is enabled if the selection signal thereof is turned to “L”, and the SPI flash memory will be enabled if the control signal thereof is turned to “L”, for example. As shown in FIG. 2 and FIG. 4, the multiplexed interface is first configured as a SPI to load default codes of the BIOS from the SPI flash memory 260 (step S410). In this case, configuration of the multiplexed interface as the SPI controls outputs of the signal lines CLK, AD1, AD0 and SPI_CS0 as follows:

CLK->SPI_CLK;

AD1->SPI_MISI;

AD0->SPI_MISO; and

SPI_CSO->“L”,

wherein the “CLK->SPI_CLK” represents the SPI clock signal SPI_CLK is output to the multiplexed clock signal line CLK, and so on.

Because the control signal SPI_CSO is set to “L”, the SPI flash memory 260 is enabled and starts to transmit data via the multiplexed interface. It is then determined whether the loading operation of the codes of the BIOS is completed (step S420). If not, the operating mode continues to access the SPI flash memory, and thus the configurations for the shared signal lines (i.e. signal lines CLK, AD1 and AD0) of the multiplexed interface are unchanged. After the loading operation is completed (Yes in step S420), the operating mode is switched to access the LPC device. The multiplexed interface is auto-configured as a LPC interface to access the LPC device. In this case, to configure the multiplexed interface as the LPC interface is to control the outputs of the signal lines CLK, AD1, AD0, LPC_FRAMES, and SPI_CS0 as follows:

SPI_CSO->“H”;

CLK->LPC_CLK;

AD1->LPC_AD1;

AD0->LPC_AD0; and

LPC_FRAME->“L”,

wherein the “CLK->LPC_CLK” represents the LPC clock signal LPC_CLK is output to the multiplexed clock signal line CLK, and so on.

The control signal SPI_CS0 is returned to “H” such that the SPI flash memory 260 is disabled and data transmission via the multiplexed interface is stopped. As signal LPC_FRAME is set to low level “L”, the LPC device is enabled and starts to transmit data via the multiplexed interface. Therefore, the bridge accesses the LPC device, and the operating mode thereof is to access the LPC device. Accordingly, it is determined whether the operating mode is switched to access the SPI flash memory 260 (step S440). If not, the operating mode continues accessing the LPC device and thus the configurations for the shared signal lines of the multiplexed interface are unchanged. If the operating mode is switched to access the SPI flash memory 260 (Yes in step S440), the multiplexed interface is auto-configured as the SPI to access the SPI flash memory 260 (step S450). Again, it is checked whether the access to the SPI flash memory 260 is completed (step S460). If not, the operating mode continues accessing the SPI flash memory, and thus the configurations for the shared signal lines of the multiplexed interface are unchanged. After the access to the SPI flash memory 260 is completed (Yes in step S460), the operating mode is switched to access the LPC device. Therefore, as in step S430, the multiplexed interface is auto-configured as a LPC interface to access the LPC device. According to the bridge design of the invention, the bridge is capable of dynamically switching the configurations for the shared signal lines of the multiplexed interface in response to the operating mode thereby switching the access between the LPC device and the SPI device. Thus, the bridge is capable of supporting data access via both LPC interface and SPI.

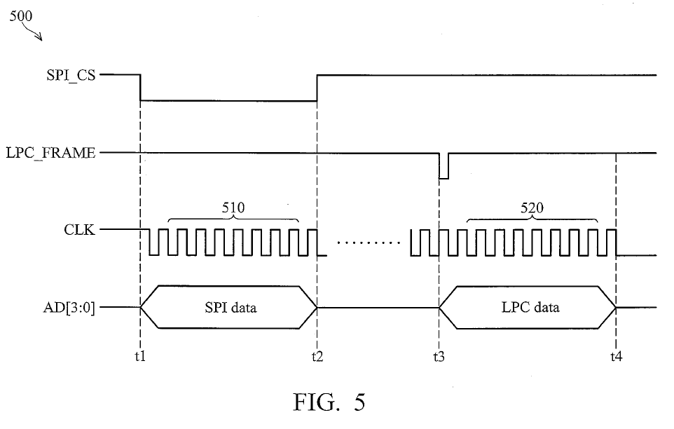

For example, FIG. 5 is an exemplary timing diagram according to an embodiment of the invention. The timing diagram 500 represents the variation of a control signal line SPI_CS of a SPI device, a selection signal line LRC_FRAME of the LPC device, a multiplexed clock signal line CLK, and data signal lines AD[3:0]. As shown in FIG. 5, time duration t1 to t2 represents a SPI operation cycle for accessing a SPI device while time duration t3 to t4 is a LPC operation cycle for accessing a LPC device. At time t1, the control signal line SPI_CS is pulled down to the low level “L” so that the SPI device is enabled. Then, the multiplexed clock signal line CLK outputs a clock signal 510 with a first frequency and the data signal lines AD[3:0] output SPI data, wherein the first frequency is compatible with the SPI standard. Thereafter, the SPI data is received by the SPI device. At time t2, the transmission of the SPI data has been completed, so the control signal line SPI-CS is pulled to the high level “H”, stopping the SPI device from receiving data from the data signal lines AD[3:0].

Next, at time t3, the selection signal line LPC_FRAME is first pulled to low level “L” and then pulled to the high level “H” to generate a pulse signal such that the LPC device is enabled. Then, the multiplexed clock signal line CLK outputs a clock signal 520 with a second frequency and the data signal lines AD[3:0] output LPC data, wherein the second frequency is compatible with the LPC standard. Thereafter, the LPC data is received by the LPC device. At time t4, the transmission of the LPC data has been completed, so the output of the multiplexed clock signal line CLK is stopped, forcing the LPC device stop receiving data from the data signal lines AD[3:0]. Thus, from above, a goal for dynamically supporting the access to the LPC interface and the SPI can be achieved by controlling the outputs of the shared pins of the multiplexed interface.

Although LPC interface and SPI are used to illustrate the disclosure, it is to be understood that the invention is not limited thereto. According to the bridge design and interface control method, other interfaces for data transmission (such as a MMC interface) may be applied in another multiplexed interface to share part of the pins of the multiplexed interface to reduce the required pin number of the bridge and switch between the interfaces coupled thereto dynamically.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A bridge, comprising:
at least one multiplexed clock signal line; and
a plurality of data signal lines,
wherein the bridge selectively outputs a first clock signal or a second clock signal to the multiplexed clock signal line according to an operating mode for accessing a first device or a second device coupled to the bridge respectively.

2. The bridge as claimed in claim 1, wherein the first device is coupled to the data signal lines and the second device is coupled to a part of the data signal lines.

3. The bridge as claimed in claim 1, further comprising an arbiter for identifying the clock signal output to the multiplexed clock signal line according to the operating mode.

4. The bridge as claimed in claim 3, wherein the arbiter determines to output the first clock signal to the multiplexed clock signal line and selects first data for output to the data signal lines when the operating mode is to access the first device.

5. The bridge as claimed in claim 4, further comprising a first controller for generating the first data.

6. The bridge as claimed in claim 3, wherein the arbiter determines to output the second clock signal to the multiplexed clock signal line and selects second data for output to the part of the data signal lines when the operating mode is to access the second device.

7. The bridge as claimed in claim 6, further comprising a second controller for generating the second data.

8. The bridge as claimed in claim 1, wherein the first device further comprises a trigger signal line, and the bridge outputs an enabling signal to the trigger signal line enabling access to the first device when the operating mode is to access the first device.

9. The bridge as claimed in claim 1, wherein the second device further comprises a selection signal line, and the bridge outputs an enabling signal to the selection signal line enabling access to the second device when the operating mode is to access the second device.

10. The bridge as claimed in claim 1, wherein the first clock signal has a first frequency and the second clock signal a second frequency, the second frequency being different from the first frequency.

11. An electronic system, comprising:
a first device having a first interface;
a second device having a second interface; and
a bridge comprising a clock pin coupled to both the first and second devices and a plurality of data pins, wherein the first interface is coupled to the data pins and the second device is coupled to a part of the data pins,
wherein the bridge selectively outputs a first clock signal or a second clock signal to the clock pin according to an operating mode for accessing the first device or the second device respectively.

12. The electronic system as claimed in claim 11, further comprising an arbiter for identifying the clock signal being output to the clock pin and outputs of the data pins according to the operating mode.

13. The electronic system as claimed in claim 12, wherein the bridge further comprises a first controller for generating first data and a second controller for generating second data, and wherein the first and second data are used by the first and second devices respectively.

14. The electronic system as claimed in claim 13, wherein the arbiter determines to output the first clock signal to the clock pin and selects the first data generated by the first controller for output to the data pins when the operating mode is to access the first device.

15. The electronic system as claimed in claim 13, wherein the arbiter determines to output the second clock signal to the clock pin and selects the second data generated by the second controller for output to the part of the data pins when the operating mode is to access the second device.

16. The electronic system as claimed in claim 11, wherein the first device further comprises a trigger pin, and the bridge outputs an enabling signal to the trigger pin enabling access to the first device when the operating mode is to access the first device.

17. The electronic system as claimed in claim 11, wherein the second device further comprises a selection pin, and the bridge outputs an enabling signal to the selection pin for enabling the access to the second device when the operating mode is to access the second device.

18. The electronic system as claimed in claim 11, wherein the first clock signal has a first frequency and the second clock signal a second frequency, the second frequency being different from the first frequency.

19. The electronic system as claimed in claim 11, wherein the first interface is a LPC (low pin count) interface and the second interface is a serial peripheral interface (SPI), and the first device is a LPC device with the LPC interface and the second device is a SPI device with the SPI, and wherein the LPC and SPI devices are coupled to the first interface of the bridge via the LPC interface and the SPI respectively.
